(19) United States
(12) Patent Application Publication
(10) Pub. No.: US 2019/0296316 A1
(43) Pub. Date: Sep. 26, 2019

(54) BATTERY TAB HAVING A LOCALIZED WELDED JOINT AND METHOD OF MAKING THE SAME

(71) Applicant: GM Global Technology Operations LLC, Detroit, MI (US)

(72) Inventors: Hongliang Wang, Sterling Heights, MI (US); Sean R. Wagner, Shelby Township, MI (US); Ryan C. Sekol, Grosse Pointe Woods, MI (US); James G. Schroth, Troy, MI (US)

(21) Appl. No.: 15/935,779

(22) Filed: Mar. 26, 2018

(51) Int. Cl. H01M 2/26; H01M 2/20; B32B 15/01; B23K 11/00; B23K 11/11; B23K 11/36

(52) U.S. Cl. CPC H01M 2/26; H01M 2/206; B32B 15/017; B23K 2201/38; B23K 11/115; B23K 11/362; H01M 2220/20; B23K 11/002

(57) ABSTRACT

A stack assembly having a battery tab with a localized weld and method of making the same is disclosed. The assembly is made by a process including the steps of arranging a plurality of battery tabs into a stack assembly; providing a resistive coating on at least one of the interior surfaces and the exterior surfaces of the battery tabs; and resistive heating the stack assembly. The resistive coating is a nickel-phosphorous (Ni—P) alloy containing 5 to 7 weight percent phosphorus. Resistive heating includes reacting the Ni—P alloy with an electric current to generate concentrated heat localized between adjacent battery tabs such that the Ni—P alloy undergoes solid-state bonding with the Cu in the first batter tab.

### INTRODUCTION

The present disclosure relates to resistive welding processes for joining metallic workpieces having similar or dissimilar metals; more particularly to an electrical conductive assembly having welded joints.

Electric vehicles utilize onboard battery packs for the storage of electrical energy. A battery pack is formed of a plurality of individual battery cells. Electrodes extending from a group of individual battery cells are joined to main electrical conductors, also known as bus bars. The electrodes, also referred to as battery tabs, are formed from thin sheets of electrically conductive material containing copper and/or aluminum. Typically, two to four battery tabs are stacked together and joined to a bus bar.

Ultrasonic welding has been used for joining battery tabs to bus bars with some success. Ultrasonic welding provides good welded joints between two sheets of similar or dissimilar materials, and between sheets of materials having substantial differences in thickness. However, for joining multiple sheets of materials, the ultrasonic energy used during the ultrasonic welding process does not transfer well across the sheet-to-sheet interfaces, especially as the number of sheets increases. If the applied ultrasonic energy level is increased substantially to maintain a critical level across multiple interfaces, the surface sheet layers tend to be damaged by the horn and/or the energy transmitted to the battery cells themselves can cause damage therein.

Soldered joints have been used for joining battery tabs to bus bars with some success. However, the use of solders with fluxing agents, particularly for aluminum, can result in the formation of corrosive flux residue that could weaken the surrounding materials or that joint over time if not adequately removed by cleaning operations following the soldering process. These cleaning operations add cost and, in some cases, may not be possible depending on the assembly sequence.

Laser welding has been used for joining battery tabs to bus bars with some success. Laser welding forms strong joints for single materials systems, but joints between copper and aluminum may be brittle due to the formation of intermetallic compounds such as CuAl2. Laser welding can be costly due to specialty equipment requirements, such as high intensity lasers and fixtures to hold the battery tab/bus bar assemblies. Furthermore, laser welding larger stacks is difficult due to uneven heat generated through layers of sheets and the potential of heat soaking into the battery cells, thus damaging the battery cells. Spatter of molten material away from the weld is also a common problem with laser welding of battery tabs.

Mechanical fasteners such as screws or clamps have also been used for joining battery tabs to bus bars with some success. However, mechanical fasteners rely on very low contact resistance to achieve good electrical conductivity. The contact resistance can degrade over time through the build-up of surface contaminants, e.g., oxides, or through degradation of the fastener.

Thus, while current methods of joining battery tabs to bus bars achieve their intended purpose, there is a need for a new and improved method.

### SUMMARY

According to several aspects, a stack assembly is disclosed. The stack assembly includes a first metallic sheet having an interior surface; a second metallic sheet adjacent the first metallic sheet, wherein the second metallic sheet includes an exterior surface facing the interior surface of the first metallic sheet; and a resistive coating disposed on at least one of the interior surface of the first metallic sheet and the exterior surface of the second metallic sheet. The resistive coating is sandwiched between the first metallic sheet and the second metallic sheet forming a bond joining the first metallic sheet to the second metallic sheet.

In an additional aspect of the present disclosure, the first metallic sheet includes copper and the resistive coating includes a nickel-phosphorous (Ni—P) alloy comprising 5 to 7 weight percent of phosphorous.

In another aspect of the present disclosure, the stack further includes a solid-state diffusion weld at an interface between the first metallic sheet and the Ni—P alloy.

In another aspect of the present disclosure, the second metallic sheet includes aluminum (Al) and the resistive coating includes a nickel-phosphorous (Ni—P) alloy comprising 5 to 7 weight percent of phosphorous.

In another aspect of the present disclosure, the stack assembly further includes an interface between the Ni—P alloy and metallic sheet containing Al. The interface contains re-solidified Al alloy.

In another aspect of the present disclosure, at least one of the first metallic sheet and the second metallic sheet comprises a metal selected from a group consisting of elemental copper (Cu), copper based alloy (Cu alloy), elemental aluminum (Al). The resistive coating comprises of a nickel-phosphorous (Ni—P) alloy. The first metallic sheet is bonded to the second metallic sheet with a layer of Ni—P alloy sandwich there-between by a process of resistive heating a localized portion of the stack assembly.

In another aspect of the present disclosure, the Ni—P alloy comprises about 5 to 7 weight percent of phosphorus.

In another aspect of the present disclosure, the stack assembly further includes a solid-state diffusion bond joining the Ni—P alloy to at least one of the first metallic sheet and the second metallic sheet comprising an elemental Cu or a Cu alloy.

In another aspect of the present disclosure, at least one of the first metallic sheet and second metallic sheet includes a thickness of about 0.2 mm.

In another aspect of the present disclosure, the stack assembly further includes a third metallic sheet joined to the second metallic sheet with a second Ni-alloy layer sandwiched there-between. The third metallic sheet includes a thickness greater than 0.2 mm.

According to several aspects, a method for joining a plurality of metal work pieces is disclosed. The method includes the steps of: a. arranging a first work piece adjacent a second work piece such that a joining surface of the first work piece is facing toward a corresponding joining surface of the second work piece; b. providing a resistive coating on at least one of the joining surface of the first work piece and the joining surface of the second work piece; c. forming an assembly by compressing the first work piece and the second work piece together such that the resistive coating is sandwiched between the joining surface of the first work piece and the joining surface of the second work piece; and d. conducting an electric current through the assembly such that that resistive coating reacts with the electric current to generate sufficient heat to generate a bond joining the first work piece to the second work piece.

In an additional aspect of the present disclosure, the resistive coating of step (b) includes a nickel phosphorus (Ni—P) alloy containing 5 to 9 weight percent of phosphorus.

In another aspect of the present disclosure, at least one of the first workpiece and the second workpiece is a metallic sheet comprising a metal selected from a group consisting of elemental copper (Cu), copper based alloy (Cu alloy), elemental aluminum (Al).

In another aspect of the present disclosure, the bond of step (d) includes a layer of Ni—P sandwiched between a portion of the first and second metallic sheets.

According to several aspects, a battery pack assembly is provided. The battery pack is made by a process including the steps of arranging a plurality of battery tabs into a stack assembly, wherein each of the battery tabs includes an exterior surface and an interior surface; providing a resistive coating on at least one of the interior surfaces and the exterior surfaces of the battery tabs; and resistive heating the stack assembly to a temperature sufficient for the resistive coating to form a bond between adjacent battery tabs, thus joining the plurality of battery tabs with a layer of resistive coating between adjacent battery tabs.

In an additional aspect of the present disclosure, the plurality of battery tabs include a first battery tab comprising copper (Cu); the resistive coating a nickel-phosphorous (Ni—P) alloy; and the step of resistive heating includes reacting the Ni—P alloy with an electric current to generate concentrated heat localized between adjacent battery tabs such that the Ni—P alloy undergoes solid-state diffusion bonding with the Cu in the first batter tab.

In another aspect of the present disclosure, the resistive coating comprises 5 to 7 weight percent phosphorus (P).

In another aspect of the present disclosure, the plurality of battery tabs include a second battery tab comprising aluminum (Al) joined to the first battery tab with a layer of Ni—P there-between.

In another aspect of the present disclosure, the battery pack further includes a bus bar joined to one of the first battery tab and the second battery tab, and a layer of Ni—P sandwiched between the bus bar and the one of the first battery tab and the second battery tab. The Ni—P is bonded to both the bus bar and the one of the first battery tab and the second battery tab, thus joining the bus bar to the one of the first battery tab and the second battery tab.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1A is a schematic illustration of a plurality of work pieces arranged in an order to be stacked and joined, according to an exemplary embodiment;

FIG. 1B is a schematic illustration of the work pieces of FIG. 1A assembled into a stacked assembly and in the process of being joined by resistive welding;

FIG. 2 is a partial cross-sectional schematic illustration of a battery pack, according to an exemplary embodiment;

FIGS. 3A-3C is a schematic illustration of a process of stacking and joining a plurality of battery tabs to a bus bar, according to an exemplary embodiment;

FIG. 4 is a schematic illustration of an alternative embodiment of a plurality of battery tabs shown in FIGS. 3A-3C, according to an exemplary embodiment; and

FIG. 5 shows a high magnification (1000×) optical photomicrograph of a prototype of an electrical conductive assembly representing a plurality of battery tabs having dissimilar metals joined to a bus bar.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not to be interpreted as limiting, but as a representative basis for teaching one skilled in the art as to how to practice the disclosed concepts.

The disclosure provides an electrical conductive stacked assembly having multiple joints produced simultaneously via the introduction of electrically resistive material at each joint, and the subsequent application of electrical current across each joint to resistively heat the local surfaces to be joined. The disclosure also provides a method of joining, by a resistive joining process, also referred to as resistive heating, a plurality of thin metallic work pieces into a stacked assembly. The method allows high strength, localized contact area joints. The method permits a large number of thin metallic workpieces, such as relatively thin metallic sheets, to be joined together. The method provides advantages in the manufacturing of electrically conductive stacked assemblies, such as battery tabs stacked onto a bus bar.

The metallic workpieces may include metallic sheets formed of elemental copper, copper-based alloys, elemental aluminum, and/or aluminum-based alloys having a relatively thin cross-sectional thickness. In one embodiment as disclosed in detail below, the stacked assembly is that of a plurality of battery tabs joined onto a bus bar. The battery tabs include a cross-sectional thickness of approximately 0.2 mm and the bus bar include a cross-sectional thickness of approximately 0.5 mm. The dimensions are provided as examples of the small magnitude of the thicknesses of the workpieces and are not intended to be so limited.

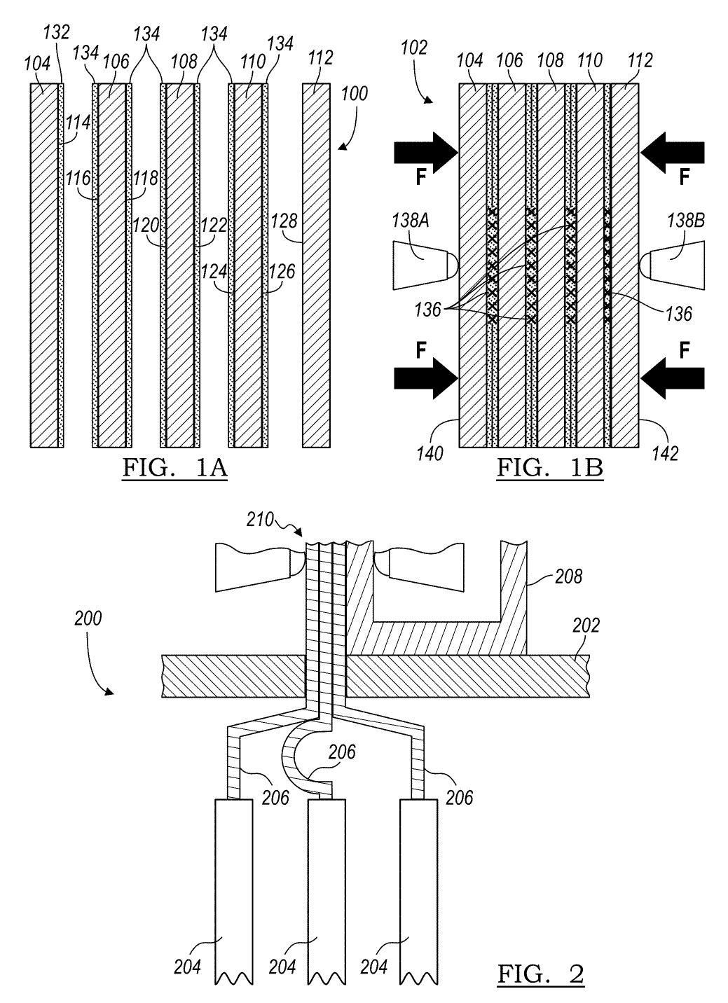

FIG. 1A shows a schematic illustration of an arrangement of a plurality of thin metallic sheets, indicated generally by reference numeral 100, positioned in an order to be stacked and joined into a stacked assembly 102 as shown in FIG. 1B. Referring to FIG. 1A, the arrangement 100 includes a first metallic sheet 104, a second metallic sheet 106, a third metallic sheet 108, a fourth metallic sheet 110, and a fifth metallic sheet 112. While five metallic sheets 104, 106, 108, 110, 112, are presented, it is not intended to be so limited. The arrangement 100 may include as few as two metallic sheets or as many as N metallic sheets, where N is the maximum number of metallic sheets that can be successfully joined by resistive heating by the method described below.

The first metallic sheet 104 includes an interior joining surface 114, the second metallic sheet 106 includes a first joining surface 116 and an opposite second joining surface 118, the third metallic sheet 108 includes a first joining surface 120 and an opposite second joining surface 122, the fourth metallic 110 sheet includes a first joining surface 124 and an opposite second joining surface 126, and the fifth metallic sheet 112 includes an interior joining surface 128. The metallic sheets 104, 106, 108, 110, 112 are arranged in an order to be stacked and assembled for joining by resistive heating. The interior joining surface 114 of the first metallic sheet 104 is facing towards the first joining surface 116 of the second metallic sheet 106. The second joining surface 118 of the second metallic sheet 106 is facing towards the first joining surface 120 of the third metallic sheet 108. The second joining surface 122 of the third metallic sheet 108 is facing toward the first joining surface 124 of the fourth metallic sheet 110. The second joining surface 126 of the fourth metallic sheet 110 is facing toward the interior joining surface 128 of the fifth metallic sheet 112.

The metallic sheets 104, 106, 108, 110, 112 are formed of an electrically conductive material selected from a group consisting of elemental Cu, elemental Al, Cu-based alloy, and Al-based alloy. The interior joining surface 114 of the first metallic sheet 104 may include a nickel (Ni) plating 129, as shown, for corrosion protection. FIG. 1 shows both the first joining surfaces 116, 120, 124 and the second joining surfaces 118, 122, 126 of the intermediate second through fourth metallic sheets 106, 108, 110 includes a nickel-phosphorus (Ni—P) coating 134 deposited by an electroless nickel (EN) plating process. However, it should be appreciated that not both the first joining surfaces 116, 120, 124 and the second joining surfaces 118, 122, 126 are required to have the Ni—P coating 134. It is sufficient that at least one of group of the first joining surfaces 116, 120, 124 or the second joining surfaces 118, 122, 126 includes the Ni—P coating 134.

The EN plating process utilizes an autocatalytic chemical reaction to deposit a uniform thickness coating of Ni—P alloy onto the metal substrates without the use of an externally applied electrical current. The EN plating process normally provides a Ni—P coating containing between 2 to 13 weight percent of phosphorus. It is desirable that the Ni—P coating 134 contains sufficient phosphorus content to provide sufficient electric resistance to concentrate the heat during the welding process. It is preferable that the range of phosphorus content is from about 5 to 9 weight percent; still more preferably, the range of phosphorus content is from about 5 to 7 weight percent.

Referring to FIG. 1B, the metallic sheets 104, 106, 108, 110, 112 are assembled into the stack assembly 102. The stack assembly 102 is then selectively Joule heated. Joule heating, also known as Ohmic heating and resistive heating, is the process by which the passage of an electric current through a conductor generates heat. In this case, an electric current is passed through the stacked assembly 102 and the high resistance of the Ni—P coating 134 between the metallic sheets 104, 106, 108, 110, 112 reacts with the electric current to generate concentrated heat localized between adjacent the metallic sheets 104, 106, 108, 110, 112. The concentrated heat and an applied compression force F create bonding between the metallic sheets 104, 106, 108, 110, 112. Typically, copper sheets undergo solid state diffusion bonding with an adjacent Ni—P layer, a Ni—P will undergo solid state diffusion bonding with an adjacent Ni—P layer, but aluminum (due to its substantially lower melting point at 660° C. as compared to the melting point of Ni—P at 1,100° C. or the melting point of copper at 1,085° C.) will typically melt during the application of electric current and will then bond with the adjacent Ni—P layer as it re-solidifies. The generation of the resistance heating specifically at the resistive Ni—P layers fosters strong bonding precisely at the initially free surfaces to be bonded while minimizing the total heat input required

The metallic sheets 104, 106, 108, 110, 112 are held in position and pressed together by pairs of forces, generally referenced as F. These forces can be introduced through an external tooling, or alternatively, by the faces of the electrodes themselves. A pair of electrodes 138 are placed on opposite surfaces of the stacked assembly 102 where the first electrode 138A is placed against an exterior surface 140 of the first metallic sheet 104 and the second electrode 138B is placed against an exterior surface 142 of the fifth metallic sheet 112. An electric current is passed between the pair of electrodes 138A, 138B through the stacked assembly 102. The resistive Ni—P coatings 134 react with the electric current to generate concentrated heat between adjacent metallic sheets 104, 106, 108, 110,112, thus forming a resistive joint 136.

In one embodiment, the stack assembly 102 shown is that of a plurality of battery tabs joined to a bus bar, in which case the first through fourth metallic sheets 104, 106, 108, 110 represent the plurality of battery tabs and includes substantially the same thickness of approximately 0.2 mm. The fifth metallic sheet represents the bus bar and includes a thickness of approximately 0.5 mm, which is substantially greater than the thicknesses of each of the first through fourth metallic sheets 104, 106, 108, 110. The battery tabs may be all elemental Cu, Cu based alloy, elemental Al, Al based alloy, or alternating elemental Cu/Cu based alloy and elemental Al/AI based alloy sheets. The bus bar may be elemental Cu, Cu based alloy, elemental Al, or Al based alloy. The Ni—P coating 134 on the first joining surfaces 116, 120, 124 and second joining surfaces 118, 122, 126 of the intermediate second through fourth metallic sheets 106, 108, 110 include a thickness of approximately 16 micrometers and contains approximately 2 to 13 weight percent P; preferably 5 to 9 weight percent P; and still more preferably, 5 to 7 weight percent P. The exterior and interior surfaces 140, 114 of the first metallic plate may be Ni plated 114 for corrosion protection.

FIG. 2 is a partial cross-sectional schematic illustration of a battery pack, generally indicated by reference number 200. The battery pack 200 includes a battery housing 202 containing a plurality of battery cells 204. Electrodes 206, such as an anodes or cathodes, extend from the battery cells 204 through the housing 202 and stacked against an external bus bar 208. The electrodes 206 are also referred to as battery tabs 206 and are formed of an electrically conductive material selected from a group of metals consisting of elemental Cu, Cu-based alloy, elemental Al, Al-based alloy. The battery tabs 206 are stacked to the bus bar 208 and resistively welded to form an electrically conductive stacked assembly 210, indicated generally by reference number 210. While three (3) battery tabs are depicted, it is not intended to be so limited; however, electrically conductive stack assembly 210 should include at least two (2) battery tabs, or at least one (1) battery tab and a bus bar 208.

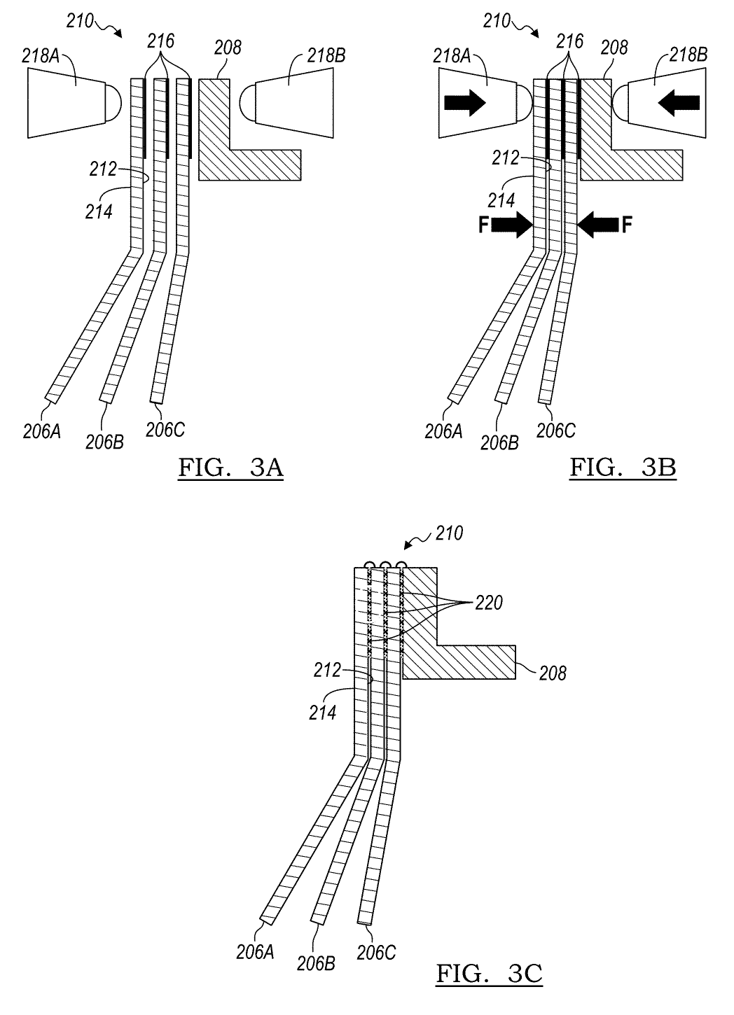

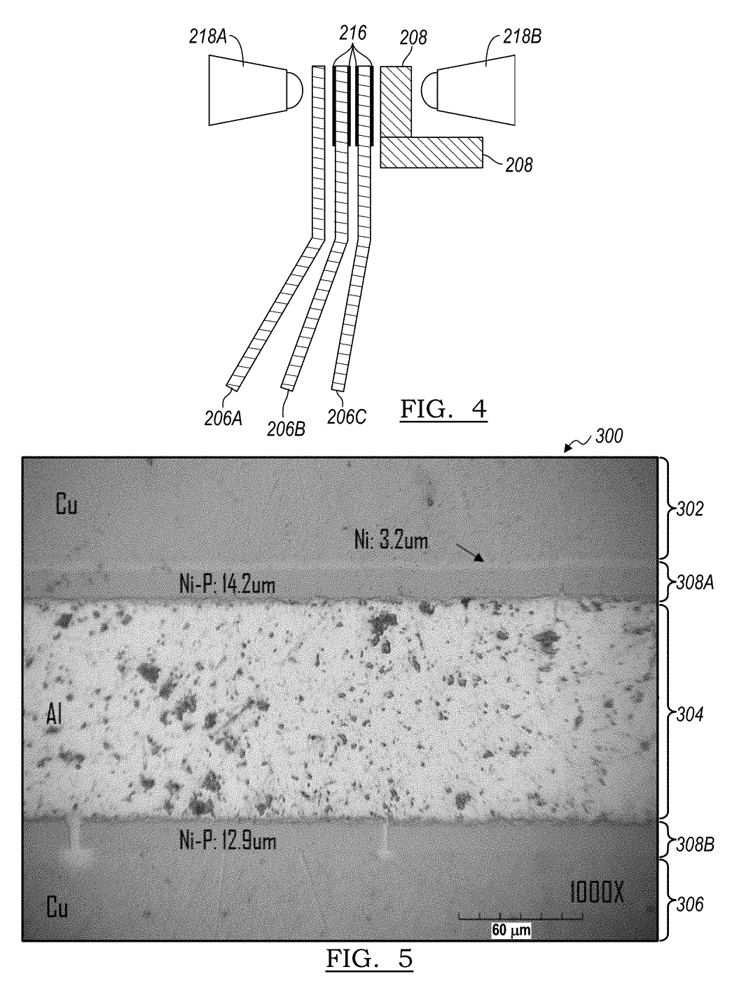

FIGS. 3A-C show a schematic cross-sectional view of an embodiment of the process illustrating three stages of joining three battery tabs 206a, 206b, 206c to the bus bar 208. FIG. 3A shows a first battery tab 206a, a second battery tab 206b immediately adjacent the first battery tab 206a, a third battery tab 206c immediately adjacent the second battery tab 206b, and the bus bar 208 immediately adjacent the third battery tab 206c. The second and third battery tabs 206b, 206c are sandwiched between the first battery tab 206a and the bus bar 208. Each of the battery tabs 206a, 206b, 206c include an interior surface 212 facing the bus bar 208 and an opposite exterior surface 214. A portion of the interior surfaces 212 of the battery tabs includes a nickel-phosphorus (Ni—P) coating 216. The battery tabs include a thickness of about 0.2 mm and the bus bar includes a thickness of about 0.5 mm, therefore it is preferable that the Ni—P coating is approximately 16 micrometers and contains approximately 5 to 7 weight percent P. Alternatively, referring to FIG. 4, both the interior and exterior surfaces 212, 214 of the interior battery tabs (the second battery tab 206b and third battery tabs 206c) are coated with the Ni—P coating 216, and at least one of the first battery tab 206a and bus bar 208 are Ni plated to reduce corrosion.

FIG. 3B shows a compressing force F compressing the first battery tab 206a and bus bar 208 together sandwiching the second and third battery tabs 206b, 206c there-between. A pair of electrodes 218a, 218b are placed on the external surfaces of the first battery tab 206a and the bus bar 208 for applying an electric current through electrically conductive stack assembly 210. The compressing force F can be introduced through external tooling, or alternatively, via the faces of the electrodes themselves. As an electric current is applied through the electrodes 218a, 218b, the resistance against the electric current provided by the Ni—P coatings 216 sandwiched between the battery cell tabs 206 generate a localized buildup of heat sufficient to cause the interface between the battery tabs 206 and the bus bar 208 to be resistively joined together. After the localized joint is formed, the electrode may be moved to another location stacked assembly 210 having the Ni—P coating 216 between adjacent pairs of battery tabs 206 and form another localized weld. FIG. 3C shows the stacked assembly 210 of battery tabs 206 and bus bar 208 joined by localized resistive welds 220.

FIG. 5 is highly magnified optical micrograph (1000×), generally indicated by reference number 300, of a cross-section of a prototype of an electrical conductive assembly representing a plurality of battery tabs having dissimilar metals joined to a bus bar. The micrograph 300 shows a cross-section of a Ni-plated Cu sheet 302 (representing a first battery tab) joined to one side of an Al sheet 304 (representing a second battery tab). The other side of the Al sheet is joined to a non-plated Cu sheet 306 (a bus bar). Prior to the assembling of the Ni-plated Cu sheet and the Cu sheet to the Al sheet, both sides of the Al sheet 304 were coated with a Ni—P coating 308a, 308b by an EN plating process.

After arranging the Ni-plated Cu sheet 302, Ni—P coated Al sheet 304, and Cu sheet 306 into a stack assembly, an electric current was conducted through the stack assembly. The resistive Ni—P coating reacted with the electric current to generate sufficient heat causing partial melting of the Al sheet due to its low melting temperature (660° C. for aluminum and about 1,100° C. for Ni—P coating). The liquid Al dissolved part of the Ni—P coating 308a, 308b (about 2-3 micrometers in this case) and formed a strong metallurgical bond during solidification. At the same time, the elevated temperature and high pressure introduced by the applied load at the faying interfaces bonded the Ni—P coating 308a and Ni plated Cu sheet 302, and also bonded the Ni—P coating 308b and non-plated Cu sheet 306 together in a solid-state format. In other words, the resistive Ni—P coating layers 308a, 308b reacted with the electric current to generate sufficient heat causing at least: (i) solid-state diffusion bonding between the Ni plated Cu sheet 302 and the first Ni—P layer 308a, (ii) locally partially melt the Al sheet 304 between the first Ni—P coating layer 308a and the second Ni—P coating layer 308b, and (iii) solid state bonding between the second Ni—P layer 308b and the Cu sheet 306.

The first and second NI—P coating layers 308a, 308b remains an integral part of the finished stack assembly 300 and is not squeezed out or removed during the resistive welding process. A continuous intermediate layer of Ni—P (first Ni—P coating layer 308a) can be clearly seen between the Ni plated Cu sheet 302 and the Al sheet 304. Also, a continuous intermediate layer of Ni—P (second Ni—P coating layer 308b) can be clearly seen between the Al sheet 304 and Cu sheet 306.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A stack assembly, comprising:
a first metallic sheet having an interior surface;
a second metallic sheet adjacent the first metallic sheet, wherein the second metallic sheet includes an exterior surface facing the interior surface of the first metallic sheet; and
a resistive coating disposed on at least one of the interior surface of the first metallic sheet and the exterior surface of the second metallic sheet;
wherein the resistive coating is sandwiched between the first metallic sheet and the second metallic sheet forming a bond joining the first metallic sheet to the second metallic sheet.

2. The stack assembly of claim 1, wherein:
the first metallic sheet comprises copper, and
the resistive coating comprises a nickel-phosphorous (Ni—P) alloy comprising 5 to 7 weight percent of phosphorous.

3. The stack assembly of claim 2, further comprising a solid-state weld at an interface between the first metallic sheet and the Ni—P alloy.

4. The stack assembly of claim 2, wherein:
the second metallic sheet comprises aluminum (Al), and
the resistive coating includes a nickel-phosphorous (Ni—P) alloy comprising 5 to 7 weight percent of phosphorous.

5. The stack assembly of claim 4, further comprising an interface between the second metallic sheet and the Ni—P alloy, wherein the interface includes a re-solidified Al alloy.

6. The stack assembly of claim 1,
wherein at least one of the first metallic sheet and the second metallic sheet comprises a metal selected from a group consisting of an elemental copper (Cu), a copper based alloy (Cu alloy), an elemental aluminum (Al), and an aluminum based alloy (Al alloy);
wherein the resistive coating comprises a nickel-phosphorous (Ni—P) alloy; and
wherein the first metallic sheet is bonded to the second metallic sheet with a layer of Ni—P alloy sandwich there-between by a process of resistive heating a localized portion of the stack assembly.

7. The stack assembly of claim 6, wherein the Ni—P alloy comprises about 5 to 7 weight percent of phosphorus.

8. The stack assembly of claim 7, further comprising a solid-state diffusion bond joining the Ni—P alloy to at least one of the first metallic sheet and the second metallic sheet comprising an elemental Cu or a Cu alloy.

9. The stack assembly of claim 8, wherein at least one of the first metallic sheet and second metallic sheet includes a thickness of about 0.2 mm.

10. The stack assembly of claim 9, further comprising a third metallic sheet joined to the second metallic sheet with a second Ni-alloy layer sandwiched there-between, wherein the third metallic sheet includes a thickness greater than 0.2 mm.

11. A method for joining a plurality of metal work pieces, comprising the steps of: a. arranging a first work piece adjacent a second work piece such that a joining surface of the first work piece is facing toward a corresponding joining surface of the second work piece;
b. providing a resistive coating on at least one of the joining surface of the first work piece and the joining surface of the second work piece;
c. forming an assembly by compressing the first work piece and the second work piece together such that the resistive coating is sandwiched between the joining surface of the first work piece and the joining surface of the second work piece; and
d. conducting an electric current through the assembly such that that resistive coating reacts with the electric current to generate sufficient heat to generate a bond joining the first work piece to the second work piece.

12. The method of claim 11, wherein the resistive coating of step (b) comprises a nickel phosphorus (Ni—P) alloy containing 5 to 9 weight percent of phosphorus.

13. The method of claim 12, wherein at least one of the first workpiece and the second workpiece is a metallic sheet comprising a metal selected from a group consisting of elemental copper (Cu), copper based alloy (Cu alloy), elemental aluminum (Al).

14. The method of claim 13, wherein the bond of step (d) includes a solid state diffusion weld between the metallic comprising Cu or Cu alloy and the Ni—P alloy.

15. The method of claim 11, wherein the bond of step (d) includes a layer of Ni—P sandwiched between a portion of the first and second metallic sheets.

16. A battery pack assembly made by a process comprising the steps of:
arranging a plurality of battery tabs into a stack assembly, wherein each of the battery tabs includes an exterior surface and an interior surface;
providing a resistive coating on at least one of the interior surfaces and the exterior surfaces of the battery tabs; and
resistive heating the stack assembly to a temperature sufficient for the resistive coating to form a bond between adjacent battery tabs, thus joining the plurality of battery tabs with a layer of resistive coating between adjacent battery tabs.

17. The battery pack of claim 16, wherein:
the plurality of battery tabs include a first battery tab comprising copper (Cu);
the resistive coating a nickel-phosphorous (Ni—P) alloy; and
the step of resistive heating includes reacting the Ni—P alloy with an electric current to generate concentrated heat localized between adjacent battery tabs such that the Ni—P alloy undergoes solid-state diffusion bonding with the Cu in the first batter tab.

18. The battery pack of claim 17, wherein the resistive coating comprises 5 to 7 weight percent phosphorus (P).

19. The battery pack of claim 18, wherein:
the plurality of battery tabs include a second battery tab comprising aluminum (Al) joined to the first battery tab with a layer of Ni—P layer there-between.

20. The battery pack of claim 19, further comprising:
a bus bar joined to one of the first battery tab and the second battery tab, and
a layer of Ni—P sandwiched between the bus bar and the one of the first battery tab and the second battery tab,
wherein the Ni—P is bonded to both the bus bar and the one of the first battery tab and the second battery tab, thus joining the bus bar to the one of the first battery tab and the second battery tab.
